(19) United States
(12) Patent Application Publication
(10) Pub. No.: US 2023/0101722 A1
(43) Pub. Date: Mar. 30, 2023

(54) RANDOM OR BLOCK POLYIMIDE SILOXANE COPOLYMER AND MANUFACTURING METHOD OF THE SAME

(71) Applicant: Research & Business Foundation SUNGKYUNKWAN UNIVERSITY, Gyeonggi-do (KR)

(72) Inventors: Nae-Eung Lee, Seoul (KR); Gargi Ghosh, Gyeonggi-do (KR)

(21) Appl. No.: 17/663,413

(22) Filed: May 13, 2022

(30) Foreign Application Priority Data
May 14, 2021 (KR) 10-2021-0062398

(51) Int. Cl. C08G 73/10; C08G 77/388; C08G 77/455; C08L 79/08

(52) U.S. Cl. CPC C08G 73/1007; C08G 73/1046; C08G 73/1071; C08G 77/388; C08G 77/455; C08L 79/08; C08L 2201/08; C08L 2201/10; C08L 2203/20

(57) ABSTRACT

The present invention provides a random or block polyimide-siloxane copolymer, which may be prepared from a hard amine monomer, a dianhydride monomer, and a soft amine monomer, may have mechanical properties, flexibility, and thermal properties adjusted through the control of soft amine content, and may exhibits high thermal stability, corrosion resistance, transparency and flexibility, and a method for preparing the same. The random or block polyimide-siloxane copolymer, which may be flexible and thermally stable and may exhibits adjustable mechanical properties and skin-like sensory functions, may be applied to flexible electronic devices.

### BACKGROUND

### Field

The present disclosure relates to a random or block polyimide-siloxane copolymer and a method for preparing the same, specifically to a random or block polyimide-siloxane copolymer, which may be prepared from a hard amine monomer, a dianhydride monomer, and a soft amine monomer, having mechanical properties, flexibility, and thermal properties that may be adjusted through the control of soft amine content.

### Description of the Related Art

Polyimide (PI) exhibits excellent mechanical strength, chemical resistance, weather resistance, heat resistance, and electrical properties such as insulating properties and low dielectric constant based on the chemical stability of imide ring.

Polyimide is a high-functional polymer, which can have minimal performance change in a low temperature region of −269° C. and a high temperature region of 400° C. and can have high mechanical strength, low thermal expansion, a low dielectric constant, and excellent solvent resistance. Polyimide is a substance which has been developed as a material for the aerospace industry and is currently applied to a wide range of areas such as molding, coating, adhesives, and films in the aircraft, industrial equipment, and electrical fields.

In order to fully implement substrates or displays including the polyimide, physical flexibility is required.

Among the functions introduced into soft electronic products featured by form factors and new functions, which may replace conventional rugged and bulky electronic products, flexibility (the ability of an assembled device to withstand mechanical deformation while maintaining normal functions) imparts robust mechanical durability and suitability to non-planar surfaces and is thus particularly important.

When polyimide is applied to microfluids, it may be difficult to overcome swelling of the microfluids and to integrate skin-like sensory functions into ultra-thin skin-like substrates to mimic the ability of human skin to be deformed in response to body movements (mechanical actions) while maintaining sensing functions (sensory abilities).

Most commercial elastomeric materials including polydimethylsiloxane (PDMS), polyurethane (PU), Ecoflex, and poly(styrene-butadiene-styrene), which are used to fabricate conventional substrates for flexible electronic devices, exhibit a low modulus of elasticity and thus are not rigid.

Conventional ultra-thin elastomer substrates have a problem that the device is not protected from excessive stretching during operation.

Conventionally, in order to enhance the rigidity and strength of the elastomer substrates, the elastomer matrix is mixed with nanofillers such as carbon nanotubes, cross-linked membranes, graphene oxide (GO), graphene or silica nanoparticles. However, when an elastomer matrix is mixed with the nanofillers, the toughness of substance may be enhanced but it is difficult to adjust the mechanical modulus.

### SUMMARY OF THE INVENTION

An object of the present invention is to provide a random or block polyimide-siloxane copolymer, which is prepared from a hard amine monomer, a dianhydride monomer, and a soft amine monomer, with mechanical properties, flexibility, and thermal properties that may be adjusted through the control of soft amine content. In some embodiments, random or block polyimide-siloxane copolymers exhibit high thermal stability, corrosion resistance, transparency and flexibility.

In some embodiments, a random polyimide-siloxane copolymer is disclosed. In some embodiments, the random polyimide-siloxane copolymer includes structural units represented by the following Chemical Formulas 1 to 3, and the following Chemical Formulas 1 to 3 may be randomly arranged and polymerized:

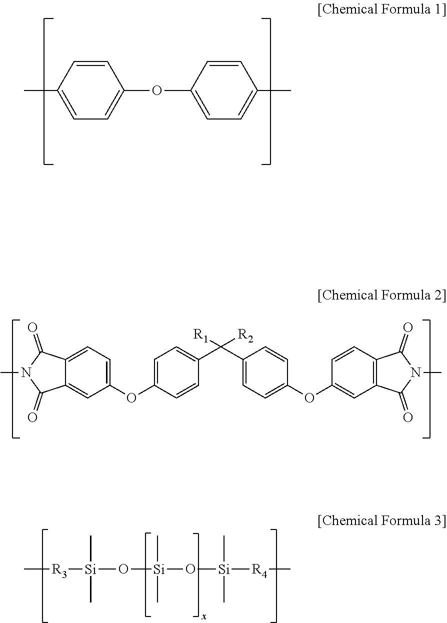

In Chemical Formula 2,

R₁ and R₂ are each independently a C₁ to C₂ chain, and

in Chemical Formula 3,

R₃ and R₄ are each independently C₃ to C₆ linear or branched alkyl, and

X is a positive rational number from 1 to 12.

The random polyimide-siloxane copolymer may have a structure represented by the following Chemical Formula 4:

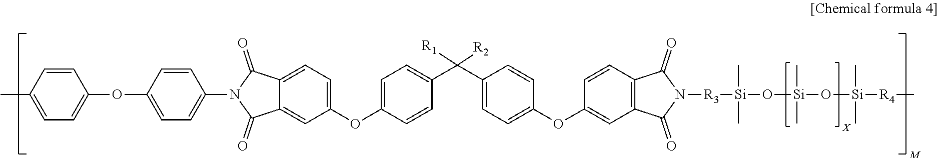

in Chemical Formula 4,

R₁ and R₂ are each independently C₁ to C₂, R₃ and R₄ are each independently C₃ to C₆ linear or branched alkyl,

X is a positive rational number from 1 to 12, and

M is an integer from 1 to 15.

The random polyimide-siloxane copolymer may exhibit thermal stability, corrosion resistance, transparency, and flexibility.

In some embodiments, a block polyimide-siloxane copolymer is disclosed. In some embodiments, the block polyimide-siloxane copolymer includes: a first block represented by the following Chemical Formula 5; and

a second block represented by the following Chemical Formula 6, and the first block and the second block may be polymerized:

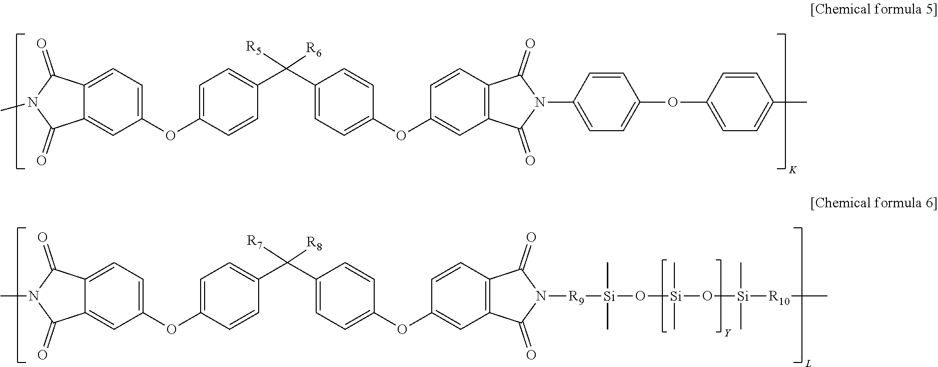

in Chemical Formula 5 and Chemical Formula 6,

R₅, R₆, R₇, and R₈ are each independently C₁ to C₂ chains, R₉ and Rio are each independently C₃ to C₆ linear or branched alkyl groups,

Y is a positive rational number from 1 to 12,

K is an integer from 1 to 15, and L is an integer from 1 to 8.

The ratio of the degree of polymerization of the second block to the degree of polymerization of the first block may be 0.5 to 1.0.

The block polyimide-siloxane copolymer may exhibit thermal stability, corrosion resistance, transparency, and flexibility.

A microfluidic device including the random polyimide-siloxane copolymer or the block polyimide-siloxane copolymer may be provided.

A flexible temperature sensor including the random polyimide-siloxane copolymer or the block polyimide-siloxane copolymer may be provided.

In some embodiments a method for preparing a random polyimide-siloxane copolymer is disclosed.

The method may include:

mixing a hard amine monomer, a dianhydride monomer, and a soft amine monomer together and then heating the mixture in a nitrogen atmosphere for reaction; and

precipitating the substance obtained after the reaction in an alcohol and performing drying to obtain a random polyimide-siloxane copolymer.

In some embodiments, the reaction conducting step may be carried out in the presence of benzene.

The content of the soft amine monomer may be controlled in a range of more than 0% and less than 100%.

In some embodiments, a method for preparing a block polyimide-siloxane copolymer is disclosed.

In some embodiments, the method may include:

mixing and then reacting a soft amine monomer with a dianhydride monomer to prepare a soft block prepolymer and mixing and then reacting a hard amine monomer with a dianhydride monomer to prepare a hard block prepolymer;

mixing the prepared soft block prepolymer with the prepared hard block prepolymer and heating the mixture in a nitrogen atmosphere for reaction; and

precipitating the substance obtained after the reaction in an alcohol and performing drying to obtain a block polyimide-siloxane copolymer.

In some embodiments, the content of the soft amine monomer may be controlled in a range of more than 0% and less than 100%.

In some embodiments, the hard amine monomer may include one selected from 4,4′-oxydianiline (ODA), 4-(4-amino-2-(trifluoromethyl)phenoxy)-3-methylaniline, 4-(4-aminophenoxy)-3-(trifluoromethyl)aniline, 4-(4-aminophenoxy)-3-fluoroaniline, 4-(4-amino-2-fluorophenoxy)-3-methylaniline, 4-(4-amino-2-(trifluoromethyl)phenoxy)-3-fluoroaniline, 4,4′-oxybis(3-(trifluoromethyl)aniline), 4,4′-oxybis(3-methylaniline), 4,4′-oxybis(3-fluoroaniline), or 4-(4-aminophenoxy)-3-methylaniline.

In some embodiments, the soft amine monomer may include one selected from aminopropyl-terminated polydimethylsiloxane (APPS), hexamethyltrisiloxane-1,5-diyl)bis(2-methylbutane-2-amine), 3-(5-(1-aminopropan-2-yl)-1,1,3,3,5,5-hexamethyltrisiloxanyl)butan-1-amine, 4-(5-(3-aminopropyl)-1,1,3,3,5,5-hexamethyltrisiloxanyl)butan-1-amine, 4-(5-(3-amino-3-methylbutyl)-1,1,3,3,5,5-hexamethyltrisiloxanyl)butyl-1-amine, or 4,4′-(1,1,3,3,5,5-hexamethyltrisiloxane-1,5-diyl)bis(butan-1-amine).

In some embodiments, the dianhydride monomer may include one selected from 4,4′-(4,4′-isopropylidenediphenoxy)bis(phthalic anhydride), 5,5′-(((difluoromethylene)bis(4,1-phenylene))bis(oxy))bis(isobenzofuran-1,3-dione), 5,5′-(((perfluoropropane-2,2-diyl)bis(4,1-phenylene))bis(oxy))bis(isobenzofuran-1,3-dione), 5,5′-(((1-fluoroethane-1,1-diyl)bis(4,1phenylene))bis(oxy))bis(isobenzofuran-1,3-dione), 5,5′-(((perfluoroethane-1,1-diyl)bis(4,1-phenylene))bis(oxy))bis(isobenzofuran-1,3-dione), 5,5′-(((fluoromethylene)bis(4,1-phenylene))bis(oxy))bis(isobenzofuran-1,3-dione), 5,5′-((ethane-1,1-diylbis(4,1-phenylene))bis(oxy))bis(isobenzofuran-1,3-dione), 5,5′-((propane-1,1-diylbis(4,1-phenylene))bis(oxy))bis(isobenzofuran-1,3-dione), 5,5′-(((1,1,1-trifluorobutane-2,2-diyl)bis(4,1-phenylene))bis(oxy))bis(isobenzofuran-1,3-dione), 5,5′-(((1-fluoropropane-1,1-diyl)bis(4,1-phenylene)bis(oxy))bis(isobenzofuran-1,3-dione), 5,5′-((butane-2,2-diylbis(4,1-phenylene))bis(oxy))bis(isobenzofuran-1,3-dione), or 5,5′-((pentane-3,3-diylbis(4,1-phenylene))bis(oxy))bis(isobenzofuran-1,3-dione).

In some embodiments, the technical objects to be achieved by the present invention are not limited by the above, and other technical objects not mentioned will be clearly understood by those skilled in the art to which the present invention pertains from the following description.

### BRIEF DESCRIPTION OF THE DRAWINGS

FIG. 1 is a scheme illustrating the synthesis process of a random polyimide-siloxane copolymer according to an embodiment.

FIG. 2 is a scheme illustrating the synthesis process of a block polyimide-siloxane copolymer according to another embodiment.

FIG. 3 is a scheme illustrating the production of a homopolymer (H0) containing only a hard amine according to another embodiment.

FIG. 4 is a scheme illustrating the production of a homopolymer (H100) containing only a soft amine according to an embodiment.

FIG. 5 is a photograph illustrating a random polyimide-siloxane copolymer (R80) according to an embodiment.

FIG. 6 is a photograph illustrating a block polyimide-siloxane copolymer (B80) according to one embodiment.

FIG. 7 is a photograph illustrating a homopolymer (H0) containing only a hard amine according to one embodiment.

FIG. 8 is a photograph illustrating a homopolymer (H100) containing only a soft amine according to one embodiment.

FIG. 9 is a graph comparing the optical transparencies of R₈₀, B80, H0 and H100 according to one embodiment.

FIG. 10 is infra-red spectrum for confirming the chemical structures of polyimide-siloxane copolymers (R₈₀ and B80) according to one embodiment.

FIG. 11 is an infra-red spectrum for confirming the chemical structure of a homopolymer (H0) according to one embodiment.

FIG. 12 is an infra-red spectrum for confirming the chemical structure of a homopolymer (H100) according to one embodiment.

FIG. 13 is a graph comparing the mechanical properties of random polyimide-siloxane copolymers (R₂₀, R₄₀, R₆₀ and R₈₀) according to one embodiment.

FIG. 14 is a graph comparing the mechanical properties of block polyimide-siloxane copolymers (B20, B40, B60 and B80) according to one embodiment.

FIG. 15 is a stress-strain curve of a homopolymer (H0) according to one embodiment.

FIG. 16 is a stress-strain curve of a homopolymer (H100) according to one embodiment.

FIG. 17 is a graph illustrating the acid resistance of polyimide-siloxane copolymers according to one embodiment.

FIG. 18 is a graph illustrating the alkali resistance of polyimide-siloxane copolymers according to one embodiment.

FIG. 19 is a graph illustrating the waterproofing properties of polyimide-siloxane copolymers according to one embodiment.

FIG. 20 is a graph illustrating the thermal stability of polyimide-siloxane copolymers according to one embodiment.

FIG. 21 is fluorescence micrographs comparing the cytotoxicity of a random polyimide-siloxane copolymer (R₈₀) with that of a control sample according to one embodiment.

FIG. 22 is a field emission scanning electron micrograph illustrating various structures of a random polyimide-siloxane copolymer (R₈₀) according to one embodiment.

FIG. 23 is photographs of a burst test performed on a random polyimide-siloxane copolymer (R₈₀) and PDMS (polydimethylsiloxane) according to an embodiment of the present invention;

FIG. 24 is a graph illustrating electrical properties when a polyimide-siloxane copolymer sample is attached to the skin according to one embodiment.

FIG. 25 is a flowchart illustrating a method for preparing a random polyimide-siloxane copolymer according to one embodiment.

FIG. 26 is a flowchart illustrating a method for preparing a block polyimide-siloxane copolymer according to one embodiment.

### DETAILED DESCRIPTION

Hereinafter, the present disclosure will be described with reference to the accompanying drawings. However, the present invention may be embodied in several different forms, and thus is not limited to the embodiments described herein. In addition, in order to clearly explain the present disclosure in the drawings, parts irrelevant to the description are omitted, and similar reference numerals are attached to similar parts throughout the specification.

Throughout the specification, when a part is said to be “connected (linked, in contact with, bonded)” to another part, this includes not only the case where a part is “directly connected” to another part but also the case where a part is “indirectly connected” to another part with still another member interposed therebetween. In addition, when a part “includes” a certain component, this means that other components are not excluded but may be further provided unless otherwise stated.

The terms used herein are used only to describe specific embodiments, and are not intended to limit the present disclosure. The singular expression includes the plural expression unless the context clearly dictates otherwise. In the present specification, it should be understood that terms such as “comprise” or “have” are intended to designate that the features, numbers, steps, operations, components, parts, or combinations thereof described in the specification exist but do not preclude the possibility of addition or existence of one or more other features, numbers, steps, operations, components, parts, or combinations thereof.

A random polyimide-siloxane copolymer and a block polyimide-siloxane copolymer according to an embodiment may include structural units represented by the following Chemical Formulas 1 to 3, and Chemical Formulas 1 to 3 may be randomly arranged and polymerized:

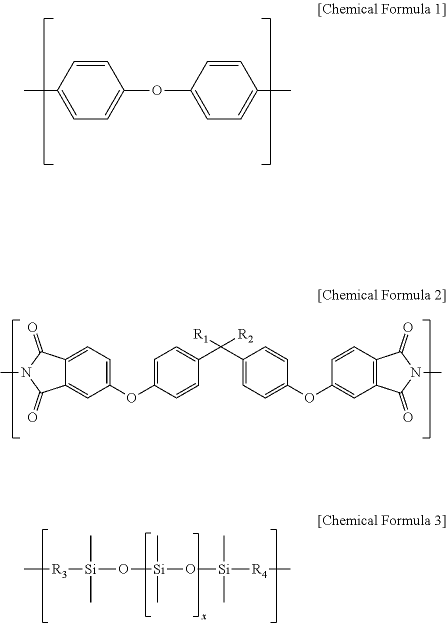

in Chemical Formula 2,

R₁ and R₂ may each independently at least one of C₁ to C₂ chains, and in Chemical Formula 3,

R₃ and R₄ may each independently at least one of linear or branched alkyls of C₃ to C₆, and

X may be a positive rational number from 1 to 12.

A random polyimide-siloxane copolymer represented by the following Chemical Formula 4 may be prepared by random arrangement of Chemical Formulas 1 to 3 and polymerization.

In some embodiments, a random polyimide-siloxane copolymer having a structure represented by the following Chemical Formula 4 is disclosed:

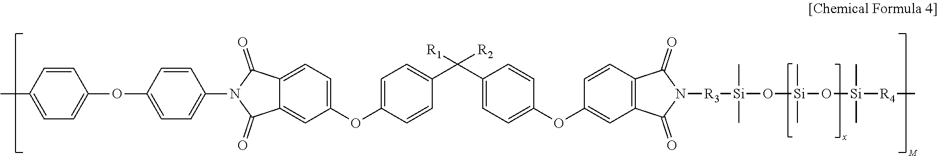

in Chemical Formula 4,

R₁ and R₂ may each independently at least one of C₁ to C₂, R₃ and R₄ are each independently at least one of linear or branched alkyls of C₃ to C₆,

X is a positive rational number from 1 to 12, and

M is an integer from 1 to 15.

In some embodiments, a C₁ to C₂ chain may be a methyl or an ethyl group, e.g., a methyl- or ethyl-ligand.

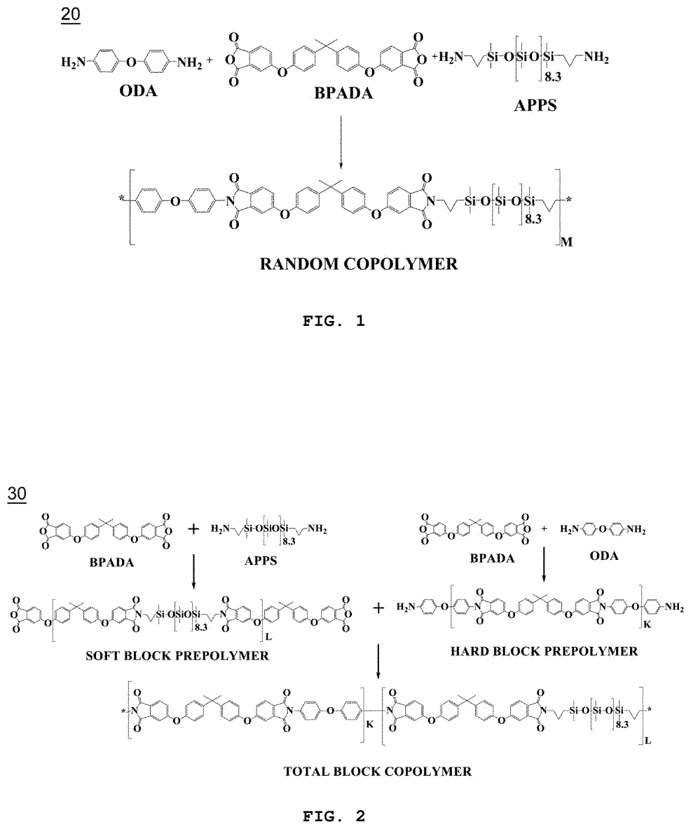

FIG. 1 is a scheme illustrating the synthesis process of a random polyimide-siloxane copolymer according to one embodiment.

The random polyimide-siloxane copolymer according to an embodiment is a substance in which a hard amine monomer, a soft amine monomer, and a dianhydride monomer are combined through a polymerization reaction.

In FIG. 1, 4,4′-oxydianiline (ODA), 4-(4-amino-2-(trifluoromethyl)phenoxy)-3-methylaniline, 4-(4-aminophenoxy)-3-(trifluoromethyl)aniline, 4-(4-aminophenoxy)-3-fluoroaniline, 4-(4-amino-2-fluorophenoxy)-3-methylaniline, 4-(4-amino-2-(trifluoromethyl)phenoxy)-3-fluoroaniline, 4,4′-oxybis(3-(trifluoromethyl)aniline), 4,4′-oxybis(3-methylaniline), 4,4′-oxybis(3-fluoroaniline), or 4-(4-aminophenoxy)-3-methylaniline may be contained as a hard amine, and

aminopropyl-terminated polydimethylsiloxane (APPS), 4,4′-(1,1,3,3,5,5-hexamethyltrisiloxane-1,5-diyl)bis(2-methylbutane-2-amine), 3-(5-(1-aminopropan-2-yl)-1,1,3,3,5,5-hexamethyltrisiloxanyl)butan-1-amine, 4-(5-(3-aminopropyl)-1,1,3,3,5,5-hexamethyltrisiloxanyl)butan-1-amine, 4-(5-(3-amino-3-methylbutyl)-1,1,3,3,5,5-hexamethyltrisiloxanyl)butyl-1-amine, or 4,4′-(1,1,3,3,5,5-hexamethyltrisiloxane-1,5-diyl)bis(butan-1-amine) may be contained as a soft amine.

As a dianhydride, 4,4′-(4,4′-isopropylidenediphenoxy)bis(phthalic anhydride) (BPADA), 5,5′-(((difluoromethylene)bis(4,1-phenylene))bis(oxy))bis(isobenzofuran-1,3-dione), 5,5′-(((perfluoropropane-2,2-diyl)bis(4,1-phenylene))bis(oxy))bis(isobenzofuran-1,3-dione), 5,5′#(1-fluoroethane-1,1-diyl)bis(4,1phenylene))bis(oxy))bis(isobenzofuran-1,3-dione), 5,5′-(((perfluoroethane-1,1-diyl)bis(4,1-phenylene))bis(oxy))bis(isobenzofuran-1,3-dione), 5,5′-(((fluoromethylene)bis(4,1-phenylene))bis(oxy))bis(isobenzofuran-1,3-dione), 5,5′-((ethane-1,1-diylbis(4,1-phenylene))bis(oxy))bis(isobenzofuran-1,3-dione), 5,5′-((propane-1,1-diylbis(4,1-phenylene))bis(oxy))bis(isobenzofuran-1,3-dione), 5,5′-(((1,1,1-trifluorobutane-2,2-diyl)bis(4,1-phenylene))bis(oxy))bis(isobenzofuran-1,3-dione), 5,5′-(((1-fluoropropane-1,1-diyl)bis(4,1-phenylene)bis(oxy))bis(isobenzofuran-1,3-dione), 5,5′-((butane-2,2-diylbis(4,1-phenylene))bis(oxy))bis(isobenzofuran-1,3-dione), or 5,5′-((pentane-3,3-diylbis(4,1-phenylene))bis(oxy))bis(isobenzofuran-1,3-dione) may be contained.

Among the substances, in an embodiment of the, 4,4′-oxydianiline (ODA) may be used as a hard amine monomer, aminopropyl-terminated polydimethylsiloxane (APPS) may be used as a soft amine monomer, and 4,4′-(4,4′-isopropylidenediphenoxy)bis(phthalic anhydride) (BPADA) may be used as a dianhydride monomer.

Referring to FIG. 1, the random polyimide-siloxane copolymer may be one obtained by polymerizing a 4,4′-oxydianiline (ODA), an aminopropyl-terminated polydimethylsiloxane (APPS), and a 4,4′-(4,4′-isopropylidenediphenoxy)bis(phthalic anhydride) (BPADA).

The random polyimide-siloxane copolymer may not be limited to the substance illustrated in FIG. 1 since the respective monomers may be randomly oriented.

In the random polyimide-siloxane copolymer, the weight of aminopropyl-terminated polydimethylsiloxane (APPS), which is the soft amine, may be controlled.

The random polyimide-siloxane copolymer is expressed as R20, R40, R60 or R80 depending on the content of aminopropyl-terminated polydimethylsiloxane (APPS).

In some embodiments, R20, R40, R60 or R80 may mean that the aminopropyl-terminated polydimethylsiloxane (APPS) content is 20%, 40%, 60% or 80% respectively.

By controlling the weight of aminopropyl-terminated polydimethylsiloxane (APPS), it is possible to finely adjust the mechanical properties including: flexibility; ultra-thin thickness; Young's modulus; toughness; transparency; and biocompatibility.

In some embodiments, a block polyimide-siloxane copolymer including a first block represented by the following Chemical Formula 5; and a second block represented by the following Chemical Formula 6 is disclosed.

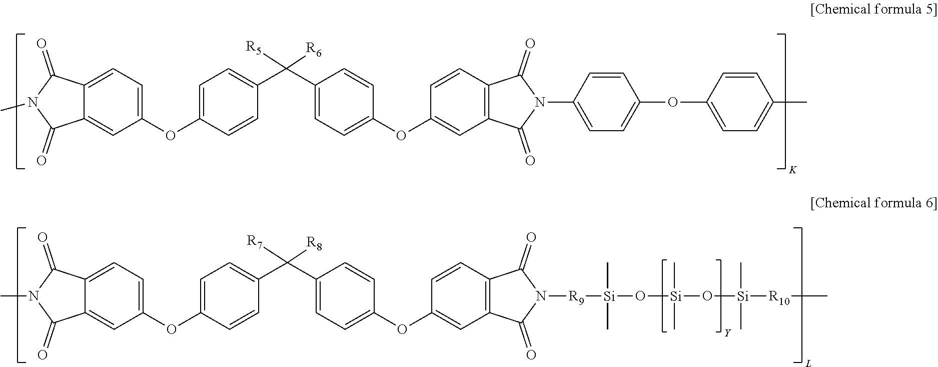

in Chemical Formula 5 and Chemical Formula 6,

R5, R6, R7, and R8 are each independently at least one of C₁ to C₂, R9 and Rio are each independently C₃ to C₆ linear or branched alkyl,

Y is a positive rational number from 1 to 12,

K is an integer from 1 to 15, and L is an integer from 1 to 8.

The block polyimide-siloxane copolymer according to an embodiment is a substance in which a hard amine monomer, a soft amine monomer and a dianhydride monomer are combined through a polymerization reaction.

In some embodiments, 4,4′-oxydianiline (ODA), 4-(4-amino-2-(trifluoromethyl)phenoxy)-3-methylaniline, 4-(4-aminophenoxy)-3-(trifluoromethyl)aniline, 4-(4-aminophenoxy)-3-fluoroaniline, 4-(4-amino-2-fluorophenoxy)-3-methylaniline, 4-(4-amino-2-(trifluoromethyl)phenoxy)-3-fluoroaniline, 4,4′-oxybis(3-(trifluoromethyl)aniline), 4,4′-oxybis(3-methylaniline), 4,4′-oxybis(3-fluoroaniline), or 4-(4-aminophenoxy)-3-methylaniline may be a hard amine, and

aminopropyl-terminated polydimethylsiloxane (APPS), 4,4′-(1,1,3,3,5,5-hexamethyltrisiloxane-1,5-diyl)bis(2-methylbutane-2-amine), 3-(5-(1-aminopropan-2-yl)-1,1,3,3,5,5-hexamethyltrisiloxanyl)butan-1-amine, 4-(5-(3-aminopropyl)-1,1,3,3,5,5-hexamethyltrisiloxanyl)butan-1-amine, 4-(5-(3-amino-3-methylbutyl)-1,1,3,3,5,5-hexamethyltrisiloxanyl)butyl-1-amine, or 4,4′-(1,1,3,3,5,5-hexamethyltrisiloxane-1,5-diyl)bis(butan-1-amine) may be a soft amine.

In some embodiments, a dianhydride may be, 4,4′-(4,4′-isopropylidenediphenoxy)bis(phthalic anhydride) (BPADA), 5,5′-(((difluoromethylene)bis(4,1-phenylene))bis(oxy))bis(isobenzofuran-1,3-dione), 5,5′-(((perfluoropropane-2,2-diyl)bis(4,1-phenylene))bis(oxy))bis(isobenzofuran-1,3-dione), 5,5′-(((1-fluoroethane-1,1-diyl)bis(4,1phenylene))bis(oxy))bis(isobenzofuran-1,3-dione), 5,5′-(((perfluoroethane-1,1-diyl)bis(4,1-phenylene))bis(oxy))bis(isobenzofuran-1,3-dione), 5,5′-(((fluoromethylene)bis(4,1-phenylene))bis(oxy))bis(isobenzofuran-1,3-dione), 5,5′-((ethane-1,1-diylbis(4,1-phenylene))bis(oxy))bis(isobenzofuran-1,3-dione), 5,5′-((propane-1,1-diylbis(4,1-phenylene))bis(oxy))bis(isobenzofuran-1,3-dione), 5,5′-(((1,1,1-trifluorobutane-2,2-diyl)bis(4,1-phenylene))bis(oxy))bis(isobenzofuran-1,3-dione), 5,5′-(((1-fluoropropane-1,1-diyl)bis(4,1-phenylene)bis(oxy))bis(isobenzofuran-1,3-dione), 5,5′-((butane-2,2-diylbis(4,1-phenylene))bis(oxy))bis(isobenzofuran-1,3-dione), or 5,5′-((pentane-3,3-diylbis(4,1-phenylene))bis(oxy))bis(isobenzofuran-1,3-dione).

In some embodiments, 4,4′-oxydianiline (ODA) is used as a hard amine monomer, aminopropyl-terminated polydimethylsiloxane (APPS) is used as a soft amine monomer, and 4,4′-(4,4′-isopropylidenediphenoxy)bis(phthalic anhydride) (BPADA) is used as a dianhydride monomer.

FIG. 2 is a scheme illustrating the synthesis process of a block polyimide-siloxane copolymer according to an embodiment.

Referring to FIG. 2, the block polyimide-siloxane copolymer may be synthesized through a two-step reaction.

In some embodiments, a soft block prepolymer may synthesized by reacting aminopropyl-terminated polydimethylsiloxane (APPS) with 4,4′-(4,4′-isopropylidenediphenoxy)bis(phthalic anhydride) (BPADA), and a hard block prepolymer is synthesized by reacting 4,4′-oxydianiline (ODA) with 4,4′-(4,4′-isopropylidenediphenoxy)bis(phthalic anhydride) (BPADA).

The final block polyimide-siloxane copolymer may be synthesized by reacting the synthesized soft block prepolymer with the synthesized hard block prepolymer.

In some embodiments, the block including the soft block prepolymer may be denoted as the first block, and the block including the hard block prepolymer may be denoted as the second block.

Still referring to FIG. 2, in some embodiments, a block polyimide-siloxane copolymer is synthesized from the first block and the second block.

In some embodiments, in the block polyimide-siloxane copolymer, the ratio of the degree of polymerization of the second block to the degree of polymerization of the first block is 0.5 to 1.0.

In some embodiments, in the block polyimide-siloxane copolymer, the weight of aminopropyl-terminated polydimethylsiloxane (APPS), which may be the soft amine, may be controlled.

In some embodiments, the block polyimide-siloxane copolymer is expressed as B20, B40, B60 or B80 depending on the content of aminopropyl-terminated polydimethylsiloxane (APPS).

In some embodiments, B20, B40, B60 or B80 may mean that the aminopropyl-terminated polydimethylsiloxane (APPS) content is 20%, 40%, 60% or 80% respectively.

In some embodiments, controlling the weight of aminopropyl-terminated polydimethylsiloxane (APPS), allows for the fine adjustment of the mechanical properties of the copolymer including: flexibility, ultra-thin thickness, Young's modulus, toughness, transparency, and biocompatibility.

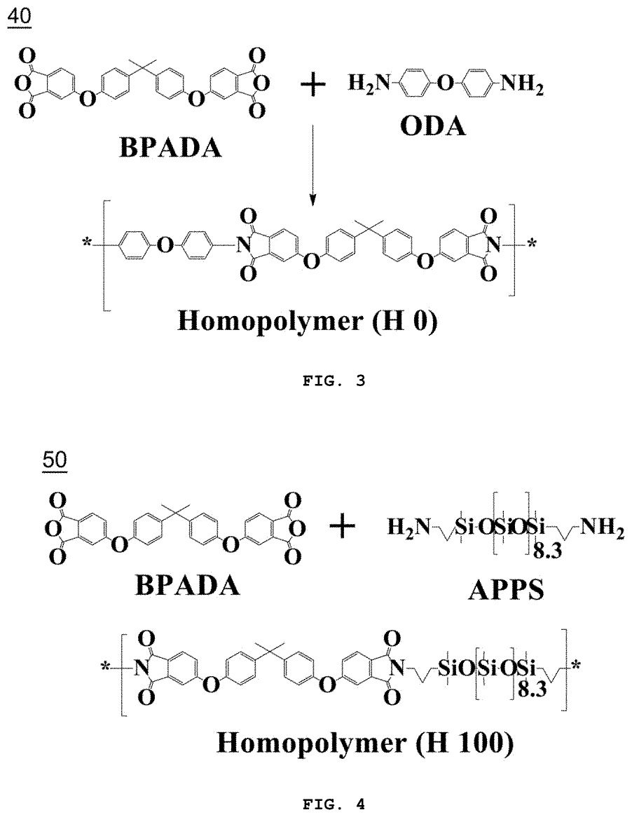

FIG. 3 and FIG. 4 illustrate homopolymers prepared to compare and explain the performance of the random or block polyimide-siloxane copolymer according to some embodiments.

In some embodiments, the homopolymers may be a homopolymers (H0) having a soft amine content of 0% and a homopolymer (H100) having a soft amine content of 100%.

FIG. 3 is a scheme illustrating the production of a homopolymer (H0) containing only a hard amine according to an embodiment of the present invention.

Referring to FIG. 3, in some embodiments, 4,4′-(4,4′-isopropylidenediphenoxy)bis(phthalic anhydride) (BPADA) reacts with 4,4′-oxydianiline (ODA) to form the homopolymer (H0).

In some embodiments, the homopolymer (H0) contains only a hard amine and has a soft amine content of 0%.

FIG. 4 is a scheme illustrating the production of a homopolymer (H100) containing only a soft amine according to an embodiment of the present invention.

Referring to FIG. 4, in some embodiments, 4,4′-(4,4′-isopropylidenediphenoxy)bis(phthalic anhydride) (BPADA) reacts with aminopropyl-terminated polydimethylsiloxane (APPS) to form the homopolymer (H100).

In some embodiments, the homopolymer (H100) has a soft amine content of 100% since the homopolymer (H100) contains only a soft amine but does not contain a hard amine.

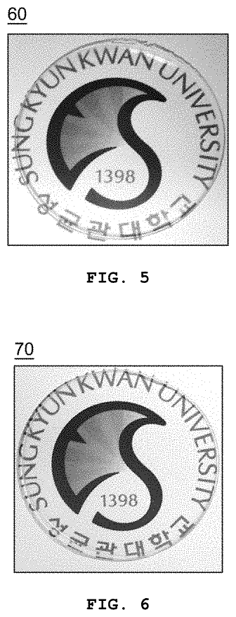

In some embodiments, the transparency of polyimide-siloxane copolymers may be described with reference to FIGS. 5 to 9.

FIG. 5 is a photograph illustrating a random polyimide-siloxane copolymer (R80) according to one embodiment.

FIG. 6 is a photograph illustrating a block polyimide-siloxane copolymer (B80) according to an embodiment.

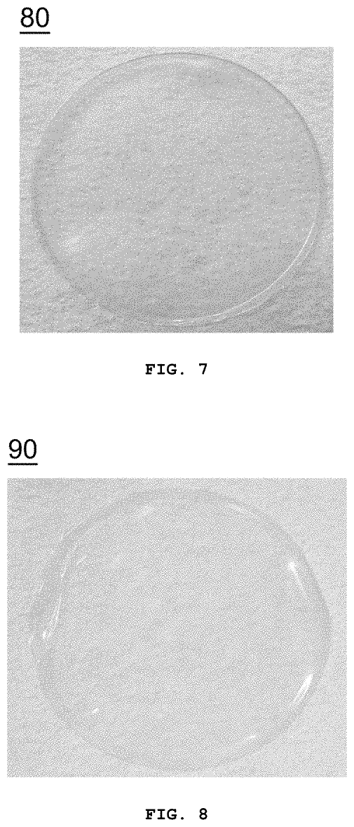

FIG. 7 is a photograph illustrating a homopolymer (H0) containing only a hard amine according to one embodiment.

FIG. 8 is a photograph illustrating a homopolymer (H100) containing only a soft amine according to one embodiment

Referring to FIGS. 5 to 8, in some embodiments, the random polyimide-siloxane copolymer of FIG. 5 and the block polyimide-siloxane copolymer of FIG. 6 are yellowish and exhibit high transparency.

In some embodiments, transparency of the homopolymer (H100) of FIG. 8 is higher than the transparency of the homopolymer (H0) of FIG. 7.

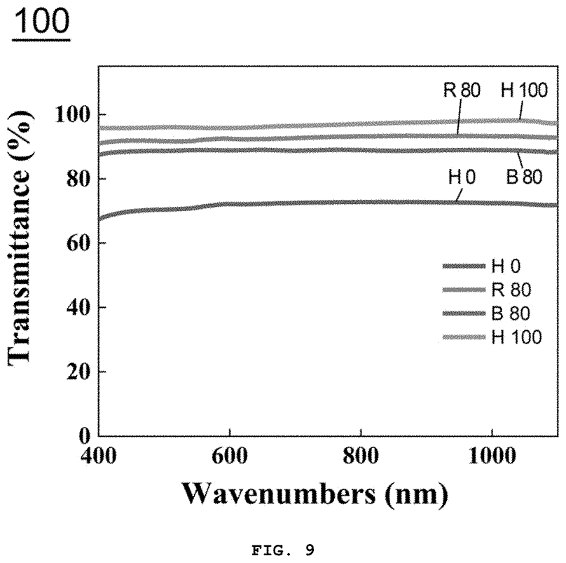

FIG. 9 is a graph comparing the optical transparencies of R80, B80, H0 and H100 according to some embodiments

Referring to FIG. 9, the transparency may be a value between 80% and 100% when aminopropyl-terminated polydimethylsiloxane (APPS), which is the soft amine, is contained and the homopolymer (H0) not containing the soft amine may have a transparency of about 70%.

In some embodiments, the polyimide-siloxane copolymers according to the present invention exhibit excellent transparency.

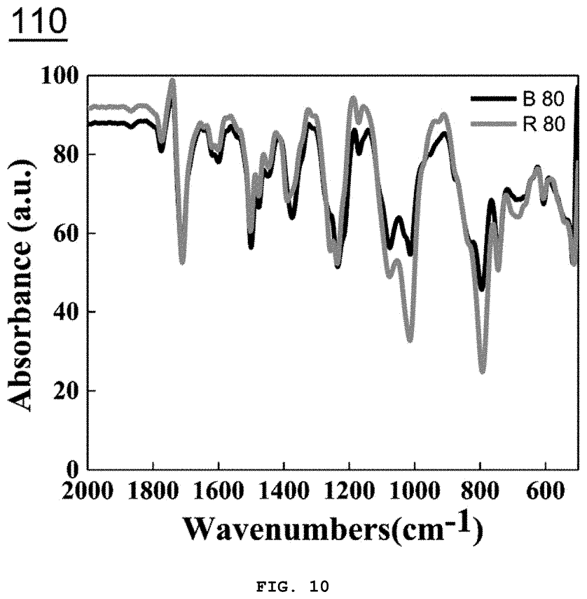

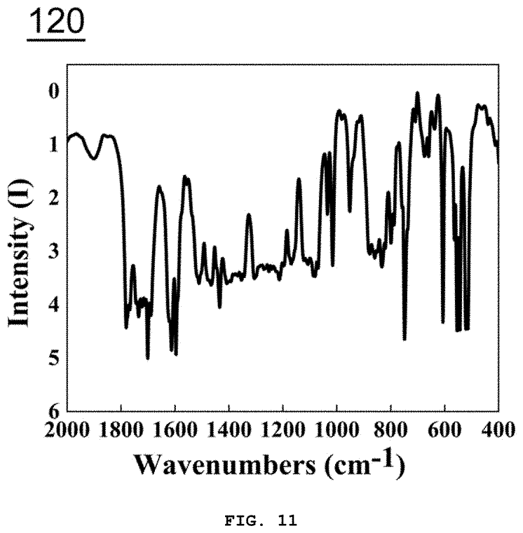

The chemical structures of some polyimide-siloxane copolymers, according to some embodiments, may be described with reference to FIGS. 10 to 12.

FIG. 10 is infra-red (“IR”) spectrum for confirming the chemical structures of polyimide-siloxane copolymers (R80 and B80) according to some embodiments.

FIG. 11 is an IR spectrum for confirming the chemical structure of a homopolymer (H0) according to some embodiments.

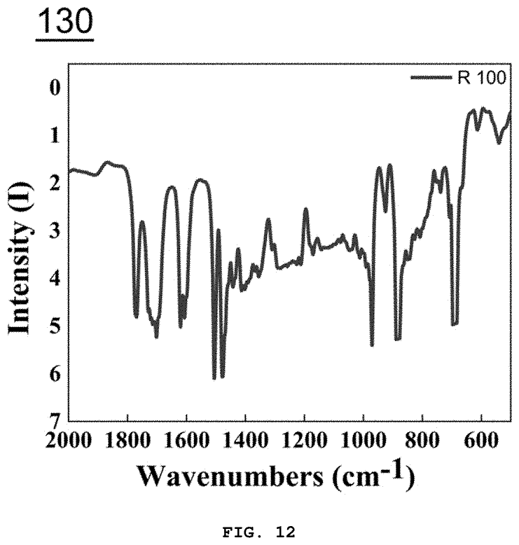

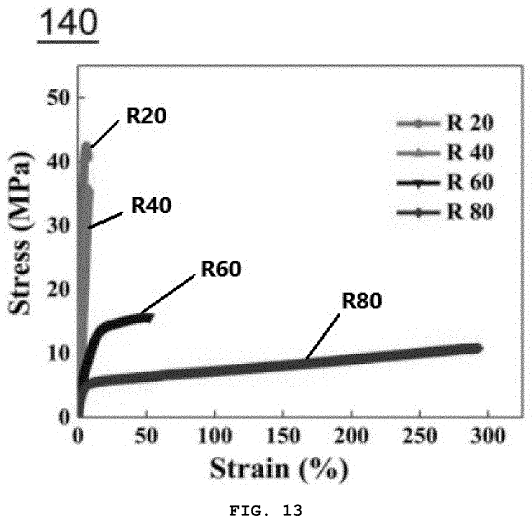

FIG. 12 is an IR spectrum for confirming the chemical structure of a homopolymer (H100) according to some embodiments.

Referring to FIG. 10, among the polyimide-siloxane copolymers prepared according to some embodiments, the chemical structures of the random polyimide-siloxane copolymer and block polyimide-siloxane copolymer in which the soft amine content is 80% can be confirmed.

In some embodiments, the formation of imide bonds can be confirmed through the fact that peaks appear at 1780 cm⁻¹ and 1720 cm⁻¹ on the IR spectra.

Referring to FIGS. 11 and 12, according to some embodiments, in some the homopolymers (H0) that do not contain a soft amine and homopolymers (H100) having a soft amine content of 100%, the formation of imide bond can be confirmed through the fact that peaks appear at 1780 cm⁻¹ and 1720 cm⁻¹ on the IR spectra.

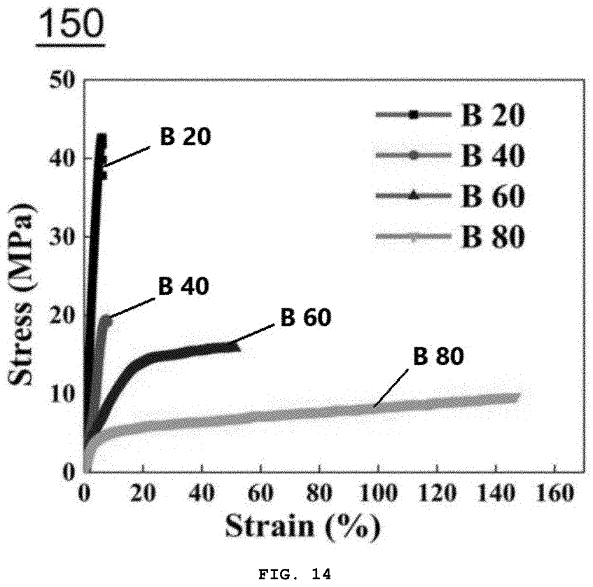

The mechanical properties of polyimide-siloxane copolymers, according to some embodiments, will be described with reference to FIGS. 13 to 14.

FIG. 13 is a graph comparing the mechanical properties of random polyimide-siloxane copolymers (R20, R40, R60 and R80) according to an embodiment.

FIG. 13 illustrates the stress-strain curves of random polyimide-siloxane copolymers R20, R40, R60 and R80 having a soft amine content of 20%, 40%, 60% and 80% respectively.

Referring to the stress-strain curves of FIG. 13, strain (%) may increase from R20 to R80 as the content of soft amine increases.

In some embodiments, mechanical properties of random polyimide-siloxane copolymers decrease as the soft amine content increases.

In some embodiments, the substance may be more hardly deformed as the mechanical strength is higher, and the substance may be more easily deformed as the mechanical properties are lower.

FIG. 14 is a graph comparing the mechanical properties of block polyimide-siloxane copolymers (B20, B40, B60 and B80) according to some embodiments.

FIG. 14 illustrates the stress-strain curves of block polyimide-siloxane copolymers B20, B40, B60 and B80 having a soft amine content of 20%, 40%, 60% and 80% respectively.

Referring to the stress-strain curves of FIG. 14, in some embodiments, strain (%) increases from B20 to B80 as the soft amine content increases.

In some embodiments, the mechanical properties of block polyimide-siloxane copolymers decrease as the soft amine content increases.

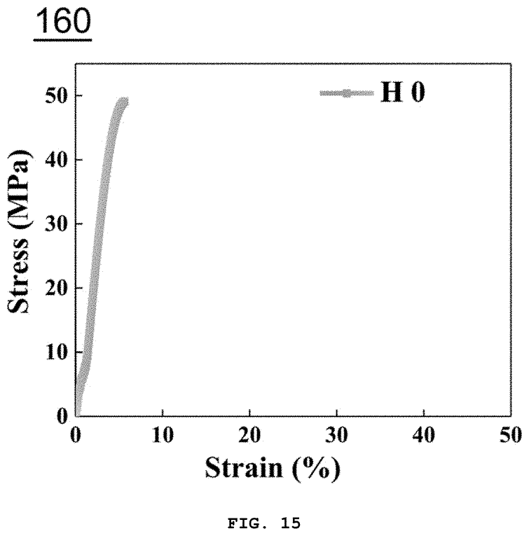

FIG. 15 is a stress-strain curve of a homopolymer (H0) according to an embodiment.

Referring to FIG. 15, in some embodiments, the strength is as high as about 50 MPa since a siloxane is not contained in the chain.

In some embodiments, the polyimide (H0) not containing a soft amine exhibits high mechanical strength.

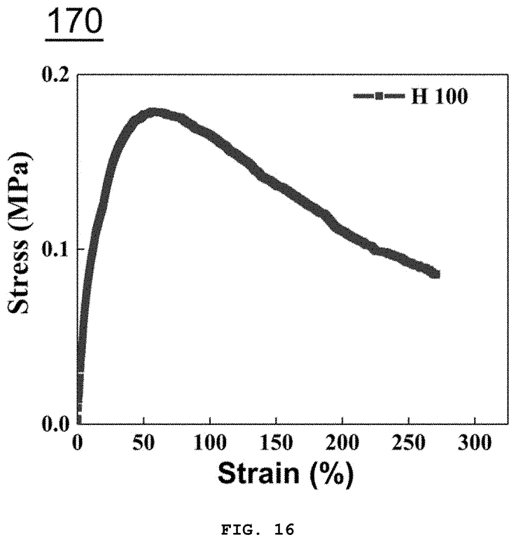

FIG. 16 is a stress-strain curve of a homopolymer (H100) according to an embodiment.

Referring to FIG. 16, in some embodiments, the strain (%) of the homopolymer (H100) is 250 or more and thus the mechanical strength is low.

Without being limited by theory, this may be because the homopolymer (H100) has a high soft amine content, thus the content of siloxane functional group in the polymer chain is significantly high, and the mechanical strength may be low and the flexibility may be significantly high.

In some embodiments, the flexibility is adjusted by the content of siloxane functional group and that a novel random or block polyimide-siloxane copolymer exhibiting low mechanical strength and high flexibility due to a siloxane functional group is produced.

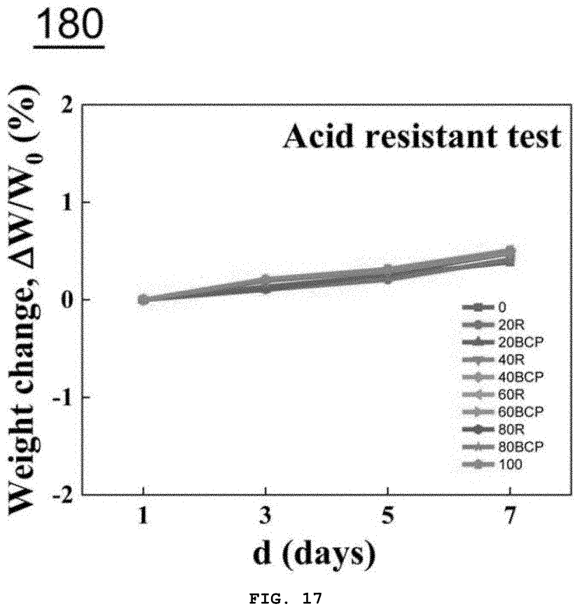

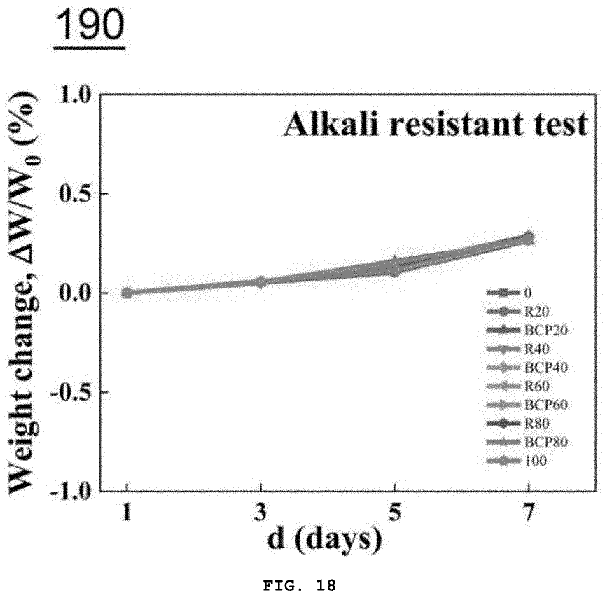

The acid resistance and alkali resistance of polyimide-siloxane copolymers will be described with reference to FIGS. 17 to 18.

FIG. 17 is a graph illustrating the acid resistance of polyimide-siloxane copolymers according to some embodiments.

Referring to FIG. 17, in some embodiments, the polyimide-siloxane copolymers have a change (ΔW/W₀) in acid resistance over time of less than 1%.

In some embodiments, the acid solution is a 1 M hydrochloric acid solution (HCl).

In some embodiments, the polyimide-siloxane copolymers may be substances stable in an acid solution through the fact that the polyimide-siloxane copolymers have little changes in weight when immersed in an acid solution for 7 days.

In some embodiments, the acid solution is a 1 M hydrochloric acid solution (HCl).

FIG. 18 is a graph illustrating the alkali resistance of polyimide-siloxane copolymers according to an embodiment of the present invention.

Referring to FIG. 18, in some embodiments, the polyimide-siloxane copolymers have a change (ΔW/Wo) in alkali resistance over time of less than 0.5%.

In some embodiments, the polyimide-siloxane copolymers may be substances stable in an alkali solution through the fact that the polyimide-siloxane copolymers have little changes in weight when immersed in a 1 M NaOH solution for 7 days.

From FIGS. 17 and 18, in some embodiments, the imide bond contained in the polyimide-siloxane copolymers of the present invention is stably formed.

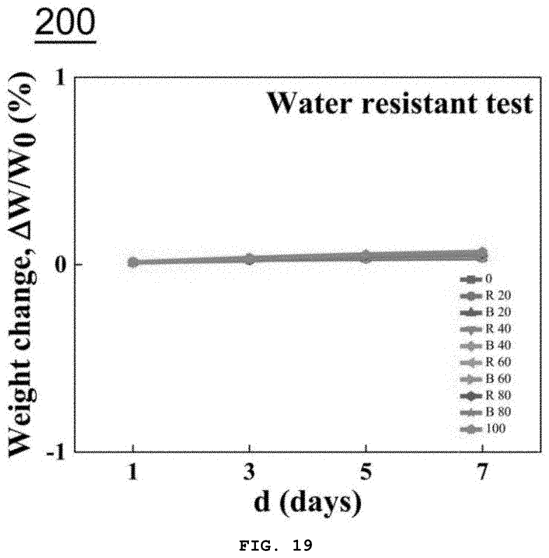

The waterproofing properties of polyimide-siloxane copolymers, according to some embodiments, will be described with reference to FIG. 19.

FIG. 19 is a graph illustrating the waterproofing properties of polyimide-siloxane copolymers according to some embodiments.

In some embodiments, the polyimide-siloxane copolymers may immersed in water, and the changes in weight (ΔW/Wo) over time is measured.

In some embodiments, the polyimide-siloxane copolymer may exhibit waterproofing properties when having little changes in weight over time.

Referring to FIG. 19, in some embodiments, the polyimide-siloxane copolymer samples and the homopolymers (H0 and H100) both may have little change in weight after 7 days.

In some embodiments, the polyimide-siloxane copolymers may exhibit waterproofing properties.

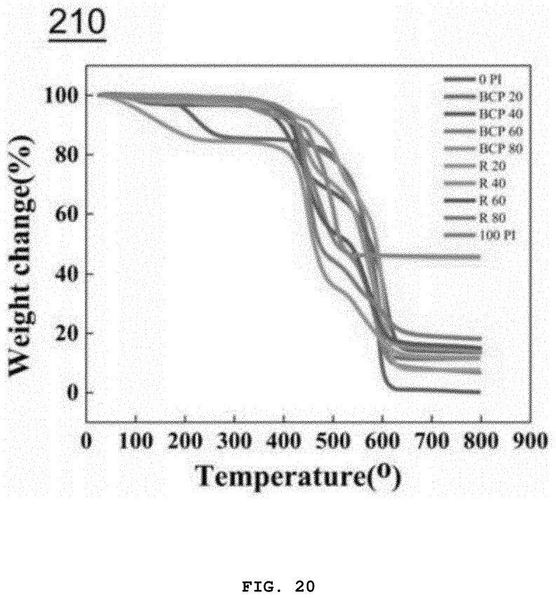

The thermal stability of polyimide-siloxane copolymers, according to some embodiments, will be described with reference to FIG. 20.

FIG. 20 is a graph illustrating the thermal stability of polyimide-siloxane copolymers according to some embodiments.

FIG. 20 illustrates changes in weight which may depend upon the temperature, in some embodiments.

Referring to FIG. 20, in some embodiments, the polyimide-siloxane copolymers (BCP20, BCP40, BCP60, BCP80, R20, R40, R60 and R80) can have a weight change rate (%) of less than 20 with increasing temperature.

In some embodiments, the weight change rate (%) may increase from the homopolymer (H0) to the homopolymer (H100) as the content of the soft amine including a siloxane increases.

In some embodiments, the polyimide-siloxane copolymers exhibit high thermal stability.

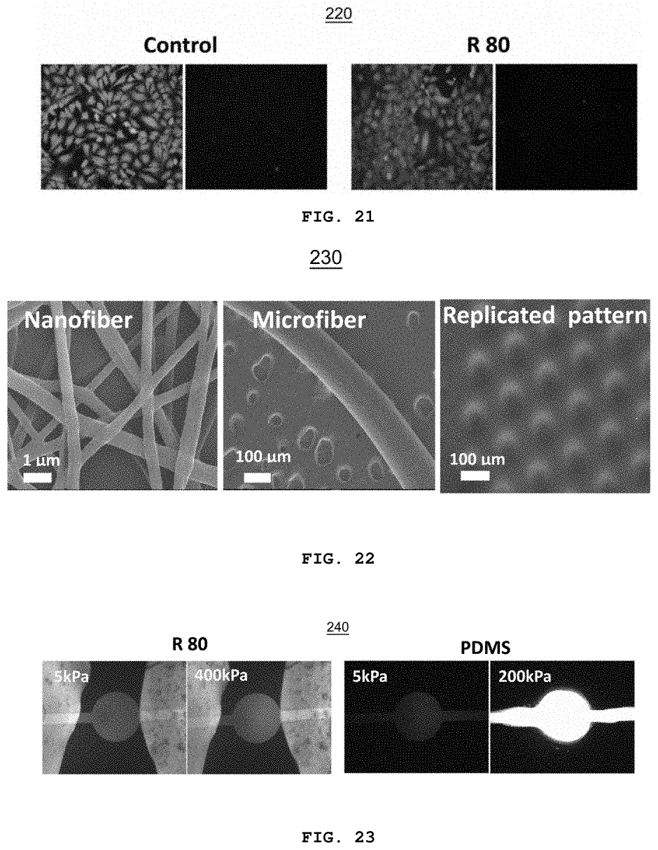

The cytotoxicity of polyimide-siloxane copolymers according to some embodiments will be described with reference to FIG. 21.

FIG. 21 is fluorescence micrographs comparing the cytotoxicity of a random polyimide-siloxane copolymer (R80), according to one embodiment, with that of a control sample.

Referring to FIG. 21, when the random polyimide-siloxane copolymer (R80) is compared to a control sample, which is nontoxic to cells and exhibits a green fluorescent color, most of the cells are alive and dead cells with red fluorescent color are not observed, showing that the polyimide-siloxane copolymer, according to some embodiments, is nontoxic to cells to an extent similar to that of the control sample.

In some embodiments, the random polyimide-siloxane copolymer may be biocompatible because of being nontoxic in the Live Dead assay.

Various structures of a polyimide siloxane copolymer will be described with reference to FIG. 22.

FIG. 22 is a series of field emission scanning electron micrographs illustrating various structures of a random polyimide-siloxane copolymer (R80) according to an embodiment.

In some embodiments, the random polyimide-siloxane copolymer (R80) has nanofiber, microfiber, and mogul pattern film structures.

In some embodiments, the random polyimide-siloxane copolymer (R80) may be formed in an arbitrary shape.

The flexibility of random polyimide-siloxane copolymers will be described with reference to FIG. 23.

FIG. 23 is a series of photographs of a burst test performed on a random polyimide-siloxane copolymer (R80) according to an embodiment and PDMS (polydimethylsiloxane).

In order to perform the burst test, first, the random polyimide-siloxane copolymer (R80) and PDMS (polydimethylsiloxane) samples are bonded to glass through oxygen plasma treatment.

Next, a burst test of the device including each of the samples is performed.

The burst test is performed by applying air pressure to the channel system of a microfluidic device, and the maximum pressure that the device can withstand may be confirmed.

It can be seen that the device including the polyimide-siloxane copolymer (R80) maintains a high pressure of 400 kPa without leakage or rupture while the device including PDMS ruptures before 200 kPa.

Without being limited by theory, this may be because PDMS absorbs molecules and thus has a problem of swelling but the polyimide-siloxane copolymer does not have a problem of swelling and thus can maintain a significantly high pressure.

Hence, it can be seen that the polyimide-siloxane copolymer exhibits excellent flexibility.

Consequently, the polyimide-siloxane copolymer, according to some embodiments, may mimic the sensory ability of human skin.

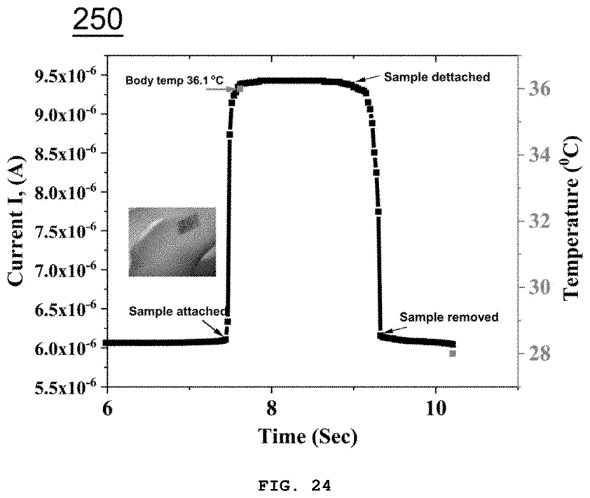

The electrical properties of polyimide-siloxane copolymers, according to some embodiments, will be described with reference to FIG. 24.

FIG. 24 is a graph illustrating electrical properties of some embodiments when a polyimide-siloxane copolymer sample according to an embodiment of the present invention is attached to the skin.

Referring to FIG. 24, it can be seen that current flows when a polyimide-siloxane copolymer is attached and the temperature is 36.1° C.

Hence, the polyimide-siloxane copolymer, according to some embodiments, may exhibit electrical properties and thus may mimic the sensory ability of the skin.

A microfluidic device including the random or block polyimide-siloxane copolymer may be fabricated.

When a polyimide-siloxane copolymer, according to some embodiments, is applied to the channel of the microfluidic device, unwanted swelling may be prevented and the contact of the microfluidic device may be improved.

In some embodiments, a flexible temperature sensor including the random or block polyimide-siloxane copolymer may be fabricated.

In some embodiments, the polyimide-siloxane copolymer may exhibit properties of thermal stability, corrosion resistance, transparency and flexibility.

In some embodiments, a polyimide-siloxane copolymer may be applied to a temperature sensor to fabricate a flexible electronic device that mimics the sensory function of human skin.

Hence, the random polyimide-siloxane copolymer and block polyimide-siloxane copolymer may exhibit excellent thermal stability, corrosion resistance, transparency and flexibility.

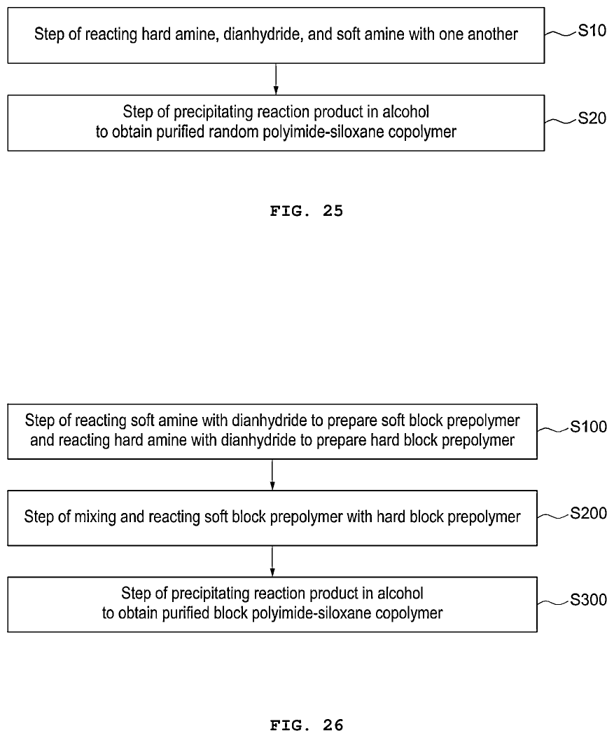

A method for preparing the polyimide-siloxane copolymers, according to some embodiments, will be described with reference to FIGS. 25 to 26.

FIG. 25 is a flowchart illustrating a method for preparing a random polyimide-siloxane copolymer according to some embodiments.

The method for preparing a random polyimide-siloxane copolymer may include a step (S10) of mixing a hard amine monomer, a dianhydride monomer, and a soft amine monomer together and then heating the mixture in a nitrogen atmosphere for reaction; and

a step (S20) of precipitating the substance obtained after the reaction in an alcohol and performing drying to obtain a random polyimide-siloxane copolymer.

In some embodiments, a step (S10) of mixing a hard amine monomer, a dianhydride monomer, and a soft amine monomer together and then heating the mixture in a nitrogen atmosphere for reaction may be included. In some embodiments, step s10 may be a first step.

In some embodiments, the reaction of a hard amine monomer, a dianhydride monomer, and a soft amine monomer with one another may be conducted in the presence of benzene. In some embodiments, this step may be a reaction step. In some embodiments, ortho-dichlorobenzene (ODCB) may be used.

In some embodiments, the hard amine monomer may include one selected from: 4,4′-oxydianiline (ODA), 4-(4-amino-2-(trifluoromethyl)phenoxy)-3-methylaniline, 4-(4-aminophenoxy)-3-(trifluoromethyl)aniline, 4-(4-aminophenoxy)-3-fluoroaniline, 4-(4-amino-2-fluorophenoxy)-3-methylaniline, 4-(4-amino-2-(trifluoromethyl)phenoxy)-3-fluoroaniline, 4,4′-oxybis(3-(trifluoromethyl)aniline), 4,4′-oxybis(3-methylaniline), 4,4′-oxybis(3-fluoroaniline), or 4-(4-aminophenoxy)-3-methylaniline.

In some embodiments, the soft amine monomer may include one selected from: aminopropyl-terminated polydimethylsiloxane (APPS), 4,4′-(1,1,3,3,5,5-hexamethyltrisiloxane-1,5-diyl)bis(2-methylbutane-2-amine), 3-(5-(1-aminopropan-2-yl)-1,1,3,3,5,5-hexamethyltrisiloxanyl)butan-1-amine, 4-(5-(3-aminopropyl)-1,1,3,3,5,5-hexamethyltrisiloxanyl)butan-1-amine, 4-(5-(3-amino-3-methylbutyl)-1,1,3,3,5,5-hexamethyltrisiloxanyl)butyl-1-amine, or 4,4′-(1,1,3,3,5,5-hexamethyltrisiloxane-1,5-diyl)bis(butan-1-amine).

In some embodiments, the dianhydride monomer may include one selected from 4,4′-(4,4′-isopropylidenediphenoxy)bis(phthalic anhydride) (BPADA), 5,5′-(((difluoromethylene)bis(4,1-phenylene))bis(oxy))bis(isobenzofuran-1,3-dione), 5,5′-(((perfluoropropane-2,2-diyl)bis(4,1-phenylene))bis(oxy))bis(isobenzofuran-1,3-dione), 5,5′-(((1-fluoroethane-1,1-diyl)bis(4,1phenylene))bis(oxy))bis(isobenzofuran-1,3-dione), 5,5′-(((perfluoroethane-1,1-diyl)bis(4,1-phenylene))bis(oxy))bis(isobenzofuran-1,3-dione), 5,5′-(((fluoromethylene)bis(4,1-phenylene))bis(oxy))bis(isobenzofuran-1,3-dione), 5,5′-((ethane-1,1-diylbis(4,1-phenylene))bis(oxy))bis(isobenzofuran-1,3-dione), 5,5′-((propane-1,1-diylbis(4,1-phenylene))bis(oxy))bis(isobenzofuran-1,3-dione), 5,5′-(((1,1,1-trifluorobutane-2,2-diyl)bis(4,1-phenylene))bis(oxy))bis(isobenzofuran-1,3-dione), 5,5′-(((1-fluoropropane-1,1-diyl)bis(4,1-phenylene)bis(oxy))bis(isobenzofuran-1,3-dione), 5,5′-((butane-2,2-diylbis(4,1-phenylene))bis(oxy))bis(isobenzofuran-1,3-dione), or 5,5′-((pentane-3,3-diylbis(4,1-phenylene))bis(oxy))bis(isobenzofuran-1,3-dione).

In some embodiments, the respective monomers may be reacted with one another by being heated at 180° C. for 12 hours in the presence of benzene.

In some embodiments, the content of the soft amine monomer may be controlled in a range of more than 0 wt. % and less than 100 wt. %.

In some embodiments, a step (S20) of precipitating the substance obtained after the reaction in an alcohol and performing drying to obtain a random polyimide-siloxane copolymer may be included. In some embodiments, step s20 may be a second step.

The substance obtained after completion of the reaction may be a viscous liquid. In some embodiments, the viscous liquid may be precipitated in methanol for purification.

In some embodiments, the purified random polyimide-siloxane copolymer may be dried to obtain a fibrous random polyimide-siloxane copolymer.

FIG. 26 is a flowchart illustrating a method for preparing a block polyimide-siloxane copolymer according to some embodiments.

The method for preparing a block polyimide-siloxane copolymer may include a step (S100) of mixing and then reacting a soft amine monomer with a dianhydride monomer to prepare a soft block prepolymer and then reacting a hard amine monomer with a dianhydride monomer to prepare a hard block prepolymer;

a step (S200) of mixing the prepared soft block prepolymer with the prepared hard block prepolymer and heating the mixture in a nitrogen atmosphere for reaction; and

a step (S300) of precipitating the substance obtained after the reaction in an alcohol and drying to obtain a block polyimide-siloxane copolymer.

In some embodiments, a step (S100) of mixing and then reacting a soft amine monomer with a dianhydride monomer to prepare a soft block prepolymer and mixing and then reacting a hard amine monomer with a dianhydride monomer to prepare a hard block prepolymer may be included. In some embodiments, step s100 is a first step.

In some embodiments, the hard amine monomer may include one selected from 4,4′-oxydianiline (ODA), 4-(4-amino-2-(trifluoromethyl)phenoxy)-3-methylaniline, 4-(4-aminophenoxy)-3-(trifluoromethyl)aniline, 4-(4-aminophenoxy)-3-fluoroaniline, 4-(4-amino-2-fluorophenoxy)-3-methylaniline, 4-(4-amino-2-(trifluoromethyl)phenoxy)-3-fluoroaniline, 4,4′-oxybis(3-(trifluoromethyl)aniline), 4,4′-oxybis(3-methylaniline), 4,4′-oxybis(3-fluoroaniline), or 4-(4-aminophenoxy)-3-methylaniline.

In some embodiments, the soft amine monomer may include one selected from aminopropyl-terminated polydimethylsiloxane (APPS), hexamethyltrisiloxane-1,5-diyl)bis(2-methylbutane-2-amine), 3-(5-(1-aminopropan-2-yl)-1,1,3,3,5,5-hexamethyltrisiloxanyl)butan-1-amine, 4-(5-(3-aminopropyl)-1,1,3,3,5,5-hexamethyltrisiloxanyl)butan-1-amine, 4-(5-(3-amino-3-methylbutyl)-1,1,3,3,5,5-hexamethyltrisiloxanyl)butyl-1-amine, or 4,4′-(1,1,3,3,5,5-hexamethyltrisiloxane-1,5-diyl)bis(butan-1-amine).

In some embodiments, the dianhydride monomer may include one selected from 4,4′-(4,4′-isopropylidenediphenoxy)bis(phthalic anhydride) (BPADA), 5,5′-(((difluoromethylene)bis(4,1-phenylene))bis(oxy))bis(isobenzofuran-1,3-dione), 5,5′-(((perfluoropropane-2,2-diyl)bis(4,1-phenylene))bis(oxy))bis(isobenzofuran-1,3-dione), 5,5′-(((1-fluoroethane-1,1-diyl)bis(4,1phenylene))bis(oxy))bis(isobenzofuran-1,3-dione), 5,5′-(((perfluoroethane-1,1-diyl)bis(4,1-phenylene))bis(oxy))bis(isobenzofuran-1,3-dione), 5,5′-(((fluoromethylene)bis(4,1-phenylene))bis(oxy))bis(isobenzofuran-1,3-dione), 5,5′-((ethane-1,1-diylbis(4,1-phenylene))bis(oxy))bis(isobenzofuran-1,3-dione), 5,5′-((propane-1,1-diylbis(4,1-phenylene))bis(oxy))bis(isobenzofuran-1,3-dione), 5,5′-(((1,1,1-trifluorobutane-2,2-diyl)bis(4,1-phenylene))bis(oxy))bis(isobenzofuran-1,3-dione), 5,5′-(((1-fluoropropane-1,1-diyl)bis(4,1-phenylene)bis(oxy))bis(isobenzofuran-1,3-dione), 5,5′-((butane-2,2-diylbis(4,1-phenylene))bis(oxy))bis(isobenzofuran-1,3-dione), or 5,5′-((pentane-3,3-diylbis(4,1-phenylene))bis(oxy))bis(isobenzofuran-1,3-dione).

In some embodiments, a step (S200) of mixing the prepared soft block prepolymer with the prepared hard block prepolymer and heating the mixture in a nitrogen atmosphere for reaction may be included. In some embodiments, step s200 is a second step.

In some embodiments, the soft block prepolymer and the hard block prepolymer may be reacted with each other by being heated at 180° C. for 12 hours in a nitrogen atmosphere.

In some embodiments, the liquid obtained after the reaction by heating may be viscous.

In some embodiments, a step (S300) of precipitating the substance obtained after the reaction in an alcohol and performing drying to obtain a block polyimide-siloxane copolymer may be included. In some embodiments, step s300 is a third step.

In some embodiments, a viscous liquid may be obtained after the reaction and may be precipitated in methanol and dried to obtain a fibrous block polyimide-siloxane copolymer.

### Preparation Example: Preparation of Random Polyimide-Siloxane Copolymer

In one experiment, a 4,4′-oxydianiline (ODA) monomer represented by the following Chemical Formula 7, a 4,4′-(4,4′-isopropylidenediphenoxy)bis(phthalic anhydride) (BPADA) monomer represented by the following Chemical Formula 8, and an aminopropyl-terminated polydimethylsiloxane (APPS) monomer represented by the following Chemical Formula 9 were prepared.

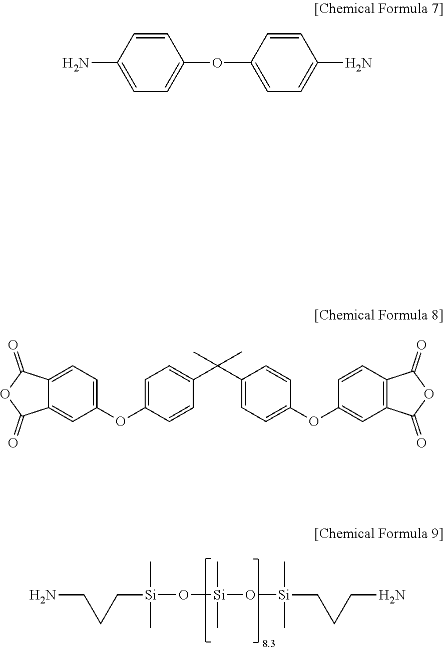

Next, 0.9 g of 4,4′-oxydianiline (ODA), 1.17359 g of 4,4′-(4,4′-isopropylidenediphenoxy)bis(phthalic anhydride) (BPADA) and 1.55 g of aminopropyl-terminated polydimethylsiloxane (APPS) were placed together in a round bottom flask and heated at 180° C. for 12 hours in a nitrogen atmosphere in the presence of ortho-dichlorobenzene (ODCB) for complete imidization.

Next, the viscous liquid obtained after heating was purified by being precipitated in methanol three times, and then dried, thereby synthesizing a fibrous random polyimide-siloxane copolymer represented by the following Chemical Formula 4.

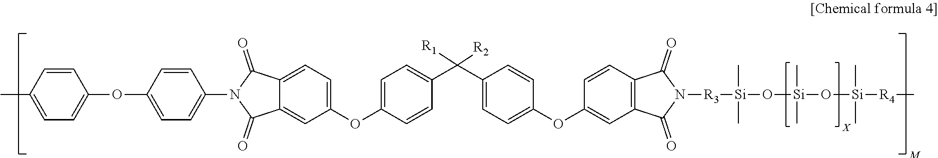

R₁ and R₂ are each independently at least one of C₁ to C₂, R₃ and R₄ are each independently at least one of linear or branched alkyls of C₃ to C₆,

X is a positive rational number from 1 to 12, and

M is an integer from 1 to 15.

### Preparation Example: Preparation of Block Polyimide-Siloxane Copolymer

First, a 4,4′-oxydianiline (ODA) monomer represented by Chemical Formula 7, a 4,4′-(4,4′-isopropylidenediphenoxy)bis(phthalic anhydride) (BPADA) monomer represented by Chemical Formula 8, and an aminopropyl-terminated polydimethylsiloxane (APPS) monomer represented by Chemical Formula 9 were prepared.

Next, at the same time, in a pot, 0.3668 g of 4,4′-(4,4′-isopropylidenediphenoxy)bis(phthalic anhydride) (BPADA) represented by Chemical Formula 8 and 1.55 g of aminopropyl-terminated polydimethylsiloxane (APPS) represented by Chemical Formula 9 were placed together in a round bottom flask and reacted to synthesize a soft block prepolymer.

In another pot, 0.09 g of 4,4′-oxydianiline (ODA) represented by Chemical Formula 7 and 0.807 g of 4,4′-(4,4′-isopropylidenediphenoxy)bis(phthalic anhydride) (BPADA) represented by Chemical Formula 8 were placed together in a round bottom flask and reacted to synthesize a hard block prepolymer.

Next, the synthesized hard block prepolymer was added to the synthesized soft block prepolymer, and the mixture was heated at 180° C. for 6 hours in a nitrogen atmosphere for complete imidization.

Next, the viscous liquid obtained after heating was purified by being precipitated in methanol and dried, thereby preparing a fibrous block polyimide-siloxane copolymer.

The present disclosure describes a random or block polyimide-siloxane copolymer, which may be prepared from a hard amine monomer, a dianhydride monomer, and a soft amine monomer, has mechanical properties, flexibility, and thermal properties adjusted through the control of soft amine content, and exhibits high thermal stability, corrosion resistance, transparency and flexibility.

In some embodiments, the random or block polyimide-siloxane copolymer, which is flexible and thermally stable and exhibits adjustable mechanical properties and skin-like sensory functions, has an effect of being able to be applied to flexible electronic devices.

The above description is for illustrative purposes, and those skilled in the art to which the present disclosure pertains will understand that the present disclosure can be easily modified into other specific forms without changing the technical spirit or essential features of the present disclosure. Therefore, it should be understood that the embodiments described above are illustrative in all respects and not restrictive. For example, each component described as a single type may be implemented in a distributed manner, and likewise components described as distributed may be implemented in a combined form.

The scope of the present disclosure is indicated by the following claims, and all changes or modifications derived from the meaning and scope of the claims and their equivalents should be construed as being included in the scope of the present disclosure.

What is claimed is:

1. A random polyimide-siloxane copolymer, comprising:
a first structural unit, a second structural unit, and a third structural unit, wherein the first structural unit, the second structural unit and the third structural unit are randomly arranged and polymerized;
wherein the first structural unit is represented by the following first general formula (F1): 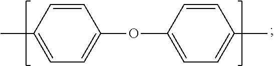
wherein the second structural unit is represented by the following second general formula (F2): 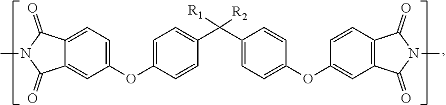
wherein in the second general formula (F2), R1 and R2 each independently represent at least one of a methyl- or ethyl group; and
wherein the third structural unit is represented by the following third general formula (F3): 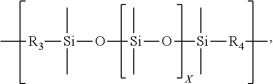
wherein in the third general formula (F3), R3 and R4 are each at least one of linear or branched alkyls of C₃ to C₆, and X is a positive rational number from 1 to 12.

2. The random polyimide-siloxane copolymer according to claim 1, with a chemical structure represented by the following fourth general formula (F4): 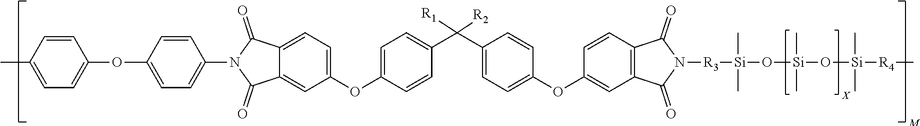
wherein R1 and R2 are each independently at least one of C₁ to C₂, R3 and R4 are each independently at least one of linear or branched alkyls of C₃ to C₆, X is a positive rational number from 1 to 12, and M is an integer from 1 to 15.

3. The random polyimide-siloxane copolymer according to claim 1, wherein the random polyimide-siloxane copolymer exhibits thermal stability, corrosion resistance, transparency, and flexibility.

4. A block polyimide-siloxane copolymer comprising:
a first block represented by the following fifth general formula (F5): 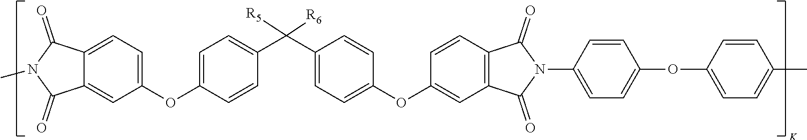
wherein in the fifth general formula (F5) R5, R6 are each independently at least one of linear or branched alkyls comprising a C₁ to C₂ carbon chain and K is an integer from 1 to 15; and
a second block represented by the following sixth general formula (F6): 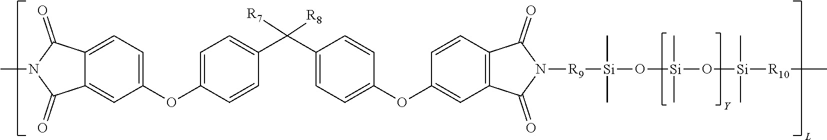
wherein in the sixth general formula (F6), R7 and R8 are each independently at least one of linear or branched alkyls of C₁ to C₂ carbon chains, R9 and Rio are each independently at least one of linear or branched alkyls of C₃ to C₆, Y is a positive rational number from 1 to 12, K is an integer from 1 to 15, L is an integer from 1 to 8; and
wherein the first block and the second block are polymerized.

5. The block polyimide-siloxane copolymer according to claim 4, wherein a ratio of a degree of polymerization of the second block to a degree of polymerization of the first block is 0.5 to 1.0.

6. The block polyimide-siloxane copolymer according to claim 4, wherein the block polyimide-siloxane copolymer exhibits thermal stability, corrosion resistance, transparency, and flexibility.

7. A microfluidic device comprising the random polyimide-siloxane copolymer of claim 1 or the block polyimide-siloxane copolymer of claim 4.

8. A flexible temperature sensor comprising the random polyimide-siloxane copolymer of claim 1 or the block polyimide-siloxane copolymer of claim 4.

9. A method for preparing a random polyimide-siloxane copolymer, the method comprising:
mixing a hard amine monomer, a dianhydride monomer, and a soft amine monomer;
heating the hard amine monomer, the dianhydride monomer, and the soft amine monomer in a nitrogen atmosphere;
precipitating, in alcohol, a substance; and
obtaining a random polyimide-siloxane copolymer by drying the substance.

10. The method for preparing the random polyimide-siloxane copolymer according to claim 9, further comprising mixing the hard amine monomer, dianhydride monomer, and soft amine monomer with benzene.

11. The method for preparing the random polyimide-siloxane copolymer according to claim 9, wherein a content of the soft amine monomer is controlled to be more than 0 weight % and less than 100 weight % of the mixture.

12. The method for preparing the random polyimide-siloxane copolymer according to claim 9, wherein the hard amine monomer comprises one or more of: 4,4′-oxydianiline (ODA), 4-(4-amino-2-(trifluoromethyl)phenoxy)-3-methylaniline, 4-(4-aminophenoxy)-3-(trifluoromethyl)aniline, 4-(4-aminophenoxy)-3-fluoroaniline, 4-(4-amino-2-fluorophenoxy)-3-methylaniline, 4-(4-amino-2-(trifluoromethyl)phenoxy)-3-fluoroaniline, 4,4′-oxybis(3-(trifluoromethyl)aniline), 4,4′-oxybis(3-methylaniline), 4,4′-oxybis(3-fluoroaniline), or 4-(4-aminophenoxy)-3-methylaniline.

13. The method for preparing the random polyimide-siloxane copolymer according to claim 9, wherein the hard amine monomer comprises one or more of: 4,4′-oxydianiline (ODA), 4-(4-amino-2-(trifluoromethyl)phenoxy)-3-methylaniline, 4-(4-aminophenoxy)-3-(trifluoromethyl)aniline, 4-(4-aminophenoxy)-3-fluoroaniline, 4-(4-amino-2-fluorophenoxy)-3-methylaniline, 4-(4-amino-2-(trifluoromethyl)phenoxy)-3-fluoroaniline, 4,4′-oxybis(3-(trifluoromethyl)aniline), 4,4′-oxybis(3-methylaniline), 4,4′-oxybis(3-fluoroaniline), or 4-(4-aminophenoxy)-3-methylaniline.

14. The method for preparing the random polyimide-siloxane copolymer according to claim 9, wherein the soft amine monomer comprises one or more of: aminopropyl-terminated polydimethylsiloxane (APPS), 4,4′-(1,1,3,3,5,5-hexamethyltrisiloxane-1,5-diyl)bis(2-methylbutane-2-amine), 3-(5-(1-aminopropan-2-yl)-1,1,3,3,5,5-hexamethyltrisiloxanyl)butan-1-amine, 4-(5-(3-aminopropyl)-1,1,3,3,5,5-hexamethyltrisiloxanyl)butan-1-amine, 4-(5-(3-amino-3-methylbutyl)-1,1,3,3,5,5-hexamethyltrisiloxanyl)butyl-1-amine, or 4,4′-(1,1,3,3,5,5-hexamethyltrisiloxane-1,5-diyl)bis(butan-1-amine).

15. The method for preparing the random polyimide-siloxane copolymer according to claim 9, wherein the dianhydride monomer comprises one or more of: 4,4′-(4,4′-isopropylidenediphenoxy)bis(phthalic anhydride), 5,5′-(((difluoromethylene)bis(4,1-phenylene))bis(oxy))bis(isobenzofuran-1,3-dione), 5,5′-(((perfluoropropane-2,2-diyl)bis(4,1-phenylene))bis(oxy))bis(isobenzofuran-1,3-dione), 5,5′-(((1-fluoroethane-1,1-diyl)bis(4,1phenylene))bis(oxy))bis(isobenzofuran-1,3-dione), 5,5′-(((perfluoroethane-1,1-diyl)bis(4,1-phenylene))bis(oxy))bis(isobenzofuran-1,3-dione), 5,5′-(((fluoromethylene)bis(4,1-phenylene))bis(oxy))bis(isobenzofuran-1,3-dione), 5,5′-((ethane-1,1-diylbis(4,1-phenylene))bis(oxy))bis(isobenzofuran-1,3-dione), 5,5′-((propane-1,1-diylbis(4,1-phenylene))bis(oxy))bis(isobenzofuran-1,3-dione), 5,5′-(((1,1,1-trifluorobutane-2,2-diyl)bis(4,1-phenylene))bis(oxy))bis(isobenzofuran-1,3-dione), 5,5′-(((1-fluoropropane-1,1-diyl)bis(4,1-phenylene)bis(oxy))bis(isobenzofuran-1,3-dione), 5,5′-((butane-2,2-diylbis(4,1-phenylene))bis(oxy))bis(isobenzofuran-1,3-dione), or 5,5′-((pentane-3,3-diylbis(4,1-phenylene))bis(oxy))bis(isobenzofuran-1,3-dione).

16. A method for preparing a block polyimide-siloxane copolymer, the method comprising:
forming a soft block prepolymer by mixing a soft amine monomer with a dianhydride monomer;
forming a hard block prepolymer by mixing a hard amine monomer with a dianhydride monomer;
mixing the soft block prepolymer with the hard block prepolymer;
heating a mixture of the soft block prepolymer and the hard block prepolymer in a nitrogen atmosphere;
precipitating, in an alcohol, a substance from the mixture of the soft block prepolymer and the hard block prepolymer; and
obtaining a block polyimide-siloxane copolymer by drying the substance.

17. The method for preparing a block polyimide-siloxane copolymer according to claim 16, wherein a content of the soft amine monomer is controlled in a range of more than 0% and less than 100%.

18. The method for preparing the block polyimide-siloxane copolymer according to claim 16, wherein the hard amine monomer comprises one or more of: 4,4′-oxydianiline (ODA), 4-(4-amino-2-(trifluoromethyl)phenoxy)-3-methylaniline, 4-(4-aminophenoxy)-3-(trifluoromethyl)aniline, 4-(4-aminophenoxy)-3-fluoroaniline, 4-(4-amino-2-fluorophenoxy)-3-methylaniline, 4-(4-amino (trifluoromethyl)phenoxy)-3-fluoroaniline, 4,4′-oxybis(3-(trifluoromethyl)aniline), 4,4′-oxybis(3-methylaniline), 4,4′-oxybis(3-fluoroaniline), or 4-(4-aminophenoxy)-3-methylaniline.

19. The method for preparing the block polyimide-siloxane copolymer according to claim 16, wherein the soft amine monomer comprises one or more of: aminopropyl-terminated polydimethylsiloxane (APPS), 4,4′-(1,1,3,3,5,5-hexamethyltrisiloxane-1,5-diyl)bis(2-methylbutane-2-amine), 3-(5-(1-aminopropan-2-yl)-1,1,3,3,5,5-hexamethyltrisiloxanyl)butan-1-amine, 4-(5-(3-aminopropyl)-1,1,3,3,5,5-hexamethyltrisiloxanyl)butan-1-amine, 4-(5-(3-amino-3-methylbutyl)-1,1,3,3,5,5-hexamethyltrisiloxanyl)butyl-1-amine, or 4,4′-(1,1,3,3,5,5-hexamethyltrisiloxane-1,5-diyl)bis(butan-1-amine).

20. The method for preparing the block polyimide-siloxane copolymer according to claim 16, wherein the dianhydride monomer comprises one or more of: 4,4′-(4,4′-isopropylidenediphenoxy)bis(phthalic anhydride), 5,5′-(((difluoromethylene)bis(4,1-phenylene))bis(oxy))bis(isobenzofuran-1,3-dione), 5,5′-(((perfluoropropane-2,2-diyl)bis(4,1-phenylene))bis(oxy))bis(isobenzofuran-1,3-dione), 5,5′-(((1-fluoroethane-1,1-diyl)bis(4,1phenylene))bis(oxy))bis(isobenzofuran-1,3-dione), 5,5′-(((perfluoroethane-1,1-diyl)bis(4,1-phenylene))bis(oxy))bis(isobenzofuran-1,3-dione), 5,5′-(((fluoromethylene)bis(4,1-phenylene))bis(oxy))bis(isobenzofuran-1,3-dione), 5,5′-((ethane-1,1-diylbis(4,1-phenylene))bis(oxy))bis(isobenzofuran-1,3-dione), 5,5′-((propane-1,1-diylbis(4,1-phenylene))bis(oxy))bis(isobenzofuran-1,3-dione), 5,5′-(((1,1,1-trifluorobutane-2,2-diyl)bis(4,1-phenylene))bis(oxy))bis(isobenzofuran-1,3-dione), 5,5′-(((1-fluoropropane-1,1-diyl)bis(4,1-phenylene)bis(oxy))bis(isobenzofuran-1,3-dione), 5,5′-((butane-2,2-diylbis(4,1-phenylene))bis(oxy))bis(isobenzofuran-1,3-dione), or 5,5′-((pentane-3,3-diylbis(4,1-phenylene))bis(oxy))bis(isobenzofuran-1,3-dione).
